(19) United States
(12) Patent Application Publication
(10) Pub. No.: US 2010/0060681 A1
(43) Pub. Date: Mar. 11, 2010

(54) PRINTING DEVICE AND PRINTING METHOD

(75) Inventor: Masaki Uchiyama, Azumino-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/554,774

(22) Filed: Sep. 4, 2009

(30) Foreign Application Priority Data
Sep. 5, 2008 (JP) 2008-228692

(51) Int. Cl. B41J 29/38; B41J 29/393

(52) U.S. Cl. 347/9; 347/19

(57) ABSTRACT

Provided is a printing device including: a printing unit which has a plurality of nozzles for ejecting a liquid and prints an image; an inspection unit which inspects whether or not the liquid can be ejected from each of the nozzles; a facsimile unit which receives image data via a communication line; and a controller which allows the inspection unit to perform the inspection at a predetermined timing when the printing unit performs the printing based on image data other than image data received by the facsimile unit and allows the inspection unit to perform the inspection before the printing regardless of the predetermined timing when the printing unit performs the printing based on the image data received by the facsimile unit.

### BACKGROUND

1. Technical Field

The present invention relates to a printing device and a printing method.

2. Related Art

In a printing device for ejecting liquid from nozzles and printing an image, the nozzles may become clogged and thus the liquid may not be ejected. If the nozzles are clogged, dot omission occurs in the formed image. This leads to the deterioration of the image quality. Accordingly, a printing device for inspecting whether or not an ink can be ejected from nozzles (hereinafter, also referred to as a dot dropout inspection) was suggested (for example, see JP-A-2007-152888). In such a printing device, the dot dropout inspection is performed at a predetermined timing and the cleaning of the nozzles is, for example, performed according to the result.

However, there is a printing device including a facsimile (hereinafter, also referred to as FAX) function. During FAX receiving, received image data is temporarily stored in a memory (buffer), or the like, and printing is performed based on the image data. However, the image data may be erased from the memory after printing. In this case, if the quality of the printed image deteriorates due to the clogging of the nozzles, the received image data cannot be printed again.

### SUMMARY

An advantage of some aspects of the invention is that it prevents the deterioration of the image quality of a printed image during FAX receiving.

According to an aspect of the invention, there is provided a printing device including: a printing unit which has a plurality of nozzles for ejecting a liquid and prints an image; an inspection unit which inspects whether or not the liquid can be ejected from each of the nozzles; a facsimile unit which receives image data via a communication line; and a controller which allows the inspection unit to perform the inspection at a predetermined timing when the printing unit performs the printing based on image data other than image data received by the facsimile unit and allows the inspection unit to perform the inspection before the printing regardless of the predetermined timing when the printing unit performs the printing based on the image data received by the facsimile unit.

The other features of the invention will become apparent from the present specification and the accompanying drawings.

### BRIEF DESCRIPTION OF THE DRAWINGS

The invention will be described with reference to the accompanying drawings, wherein like numbers reference like elements.

FIG. 1 is a block diagram showing the overall configuration of a multifunction peripheral according to the present embodiment.

FIG. 2A is a schematic view of a printer unit 50, and FIG. 2B is a lateral cross-sectional view of the printer unit 50.

FIG. 3 is an explanatory view of the configuration of a head unit 53.

FIG. 4A is an explanatory view of a cap used for pumping cleaning and FIG. 4B is a view the cap when viewed from top.

FIG. 5 is an explanatory view of a method of forming dots by the multifunction peripheral 1 according to the present embodiment.

FIG. 6 is an explanatory view of a dot dropout detection circuit 56.

FIG. 7A is an explanatory view of a driving signal COM for driving a piezoelectric element of each of the nozzles, and FIG. 7B is an explanatory view of a detection signal when ink droplets are ejected.

FIG. 8 is an explanatory view of a detection signal.

FIG. 9 is an explanatory view when noise is included in a detection signal.

FIG. 10 is a view explaining resolution conversion during FAX printing, wherein FIG. 10A shows the data of an image during FAX receiving, FIG. 10B shows the data of an image during printing, FIG. 10C is a view showing an image printed when nozzle #1 is clogged, and FIG. 10D is a view showing an image printed when nozzle #3 is clogged.

FIG. 11 is a flowchart of a printing process according to a first embodiment.

FIG. 12 is a flowchart of a printing process according to a second embodiment.

FIG. 13 is a flowchart of a printing process according to a third embodiment.

FIG. 14 is a flowchart of a printing process according to a fourth embodiment.

### DESCRIPTION OF EXEMPLARY EMBODIMENTS

### Outline of Disclosure

At least the following becomes apparent from the present specification and the accompanying drawings.

There is provided a printing device including: a printing unit which has a plurality of nozzles for ejecting a liquid and prints an image; an inspection unit which inspects whether or not the liquid can be ejected from each of the nozzles; a facsimile unit which receives image data via a communication line; and a controller which allows the inspection unit to perform the inspection at a predetermined timing when the printing unit performs the printing based on image data, other than image data received by the facsimile unit, and allows the inspection unit to perform the inspection before the printing regardless of the predetermined timing when the printing unit performs the printing based on the image data received by the facsimile unit.

According to such a printing device, since an inspection of the nozzles is necessarily performed before the image data received by the facsimile unit is printed, it is possible to prevent the deterioration of the image quality of the printing of the facsimile and to improve the certainty of the printing.

The printing device may further include a recovery unit which performs a recovery operation for recovering an ejection function of a nozzle which does not eject the liquid, and the controller may allow the recovery unit to perform the recovery operation according to the inspected result of the inspection unit.

According to such a printing device, for example, since the recovery of the ejection function of the nozzles can be realized when the nozzles are clogged, it is possible to improve the image quality of the printed image.

In the printing device, each of the pixels of the image data may be divided into a plurality of pixels and at least a predetermined number of nozzles may be used for the plurality of divided pixels, when the printing is performed based on the image data received by the facsimile unit, and the controller may allow the printing unit to perform the printing without allowing the recovery unit to perform the recovery operation if at least one of the predetermined number of nozzles corresponding to each of the pixels of the image data can eject the liquid as the inspected result of the inspection unit.

According to such a printing device, since a visible image can be printed even when the nozzle which does not eject the ink is present, it is possible to shorten the printing time.

In the printing device, the controller may determine that at least one of the predetermined number of nozzles corresponding to each of the pixels of the image data can eject the liquid if the number of nozzles which do not eject the liquid is less than the predetermined number as the inspected result of the inspection unit.

According to such a printing device, it is possible to shorten the printing time.

In the printing device, the predetermined timing may be determined according to the print amount of the printing unit or a time.

According to such a printing device, it is possible to efficiently detect the presence/absence of the nozzle which does not eject the ink.

There is provided a printing method of a printing device which has a plurality of nozzles for ejecting a liquid and prints an image based on image data, the method including: inspecting whether or not the liquid can be ejected from each of the nozzles; and receiving image data via a communication line, wherein the inspection is performed at a predetermined timing when the printing is performed based on image data other than image data received by a facsimile unit and the inspection is performed before the printing regardless of the predetermined timing when the printing is performed based on the image data received by the facsimile unit.

In addition, there is provided a printing device including: a printing unit which has a plurality of nozzles for ejecting a liquid and printing an image; an inspection unit which inspects whether or not the liquid can be ejected from each of the nozzles; a facsimile unit which receives image data via a communication line; and a controller which allows the inspection unit to perform the inspection at predetermined timing when the printing unit performs the printing based on image data other than image data received by the facsimile unit and allows the inspection unit to perform the inspection before the printing at a timing with a frequency higher than that of the predetermined timing when the printing unit performs the printing based on the image data received by the facsimile unit.

Hereinafter, the embodiment of the invention will be described using a multifunction peripheral which is one type of a printing device.

### Configuration of Multifunction Peripheral

### Regarding Configuration of Multifunction Peripheral

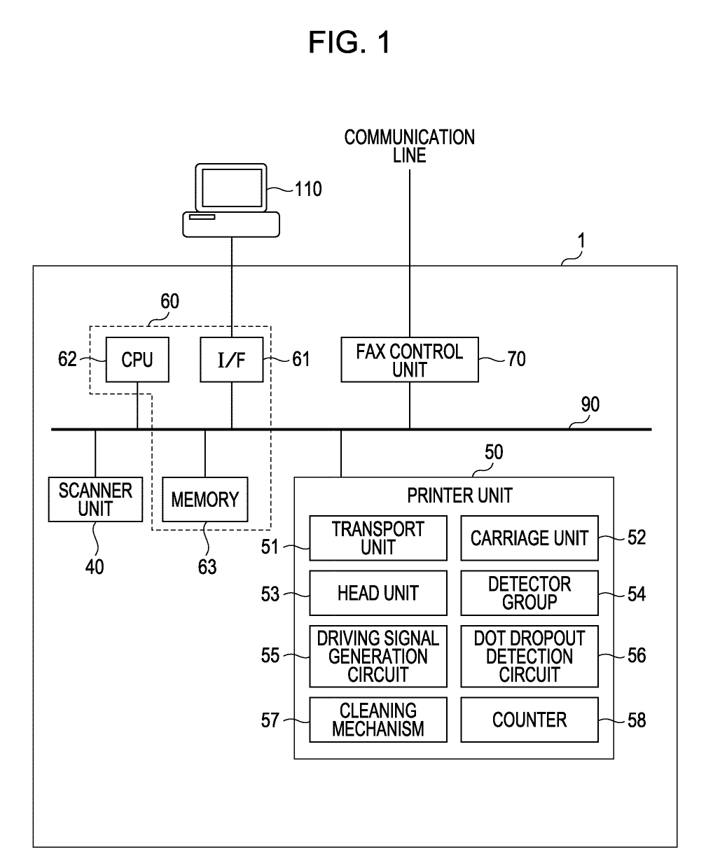

FIG. 1 is a block diagram showing the overall configuration of a multifunction peripheral 1 according to the present embodiment.

The multifunction peripheral 1 includes a scanner unit 40 for scanning and reading an original or an image, a FAX control unit 70 (corresponding to a facsimile unit) for performing facsimile (hereinafter, referred to as FAX) transmission/reception, a printer unit 50 for performing printing with respect to a print medium or the like, and a controller 60 for controlling the units (the scanner unit 40, the printer unit 50, and the FAX control unit 70) of the multifunction peripheral body. In addition, the controller 60 has an interface unit 61, a CPU 62, and a memory 63. The interface unit 61, the CPU 62, the memory 63, the scanner unit 40, the printer unit 50 and the FAX control unit 70 are connected by a bus 90.

Accordingly, the multifunction peripheral 1 has the scanner function of the scanner unit 40, the printing function of the printer unit 50, a copy function which is a combination of the scanner function and the printing function, and a FAX transmission/reception function of the FAX control unit 70.

### Regarding Controller

The controller 60 is a control unit for controlling the multifunction peripheral 1. The interface unit 61 performs data transmission/reception between a computer 110, which is an external device, and the multifunction peripheral 1. The CPU 62 is an arithmetic processing unit for controlling the overall multifunction peripheral. In addition, the CPU 62 according to the present embodiment has a timer function for measuring a time. The memory 63 is a region for storing the program of the CPU 62 or a working region and has a storage device such as a RAM, an EEPROM, or the like. In addition, the memory 63 temporarily stores image data read by the scanner unit 40 or image data received by the FAX control unit 70. The CPU 62 controls the units (the scanner unit 40, the printer unit 50 and the FAX control unit 70) according to the program stored in the memory 63.

### Regarding Scanner Unit

The scanner unit 40 irradiates light onto an original placed on an original platen (not shown), detects the reflected light by a sensor (for example, a CCD) included in a reading carriage (not shown), and reads the image of the original. This scanner unit 40 transmits image data representing the result of reading the image to the controller 60. This image data is temporarily stored in the memory 63 of the controller 60. If a copy is performed, the image data stored in the memory 63 is sent to the printer unit 50 by the controller 60 and is printed by the printer unit 50. If FAX transmission is performed, the image data stored in the memory 63 is sent to the FAX control unit 70 and is transmitted from the FAX control unit 70 to a communication line.

### Regarding Fax Control Unit

The FAX control unit 70 is connected to the communication line and performs transmission/reception of the image via the communication line.

If FAX transmission is performed, the FAX control unit 70 receives the image data read by the scanner unit 40 from the memory 63 of the controller 60 and transmits it to the communication line.

In addition, if the FAX control unit 70 receives the image data FAX-transmitted from the communication line, the FAX control unit 70 stores the received data in the memory 63 of the controller 60 and issues a print command to the controller 60. In addition, the image data stored in the memory 63 is sent to the printer unit 50 by the controller 60 and is printed by the printer unit 50.

### Regarding Printer Unit

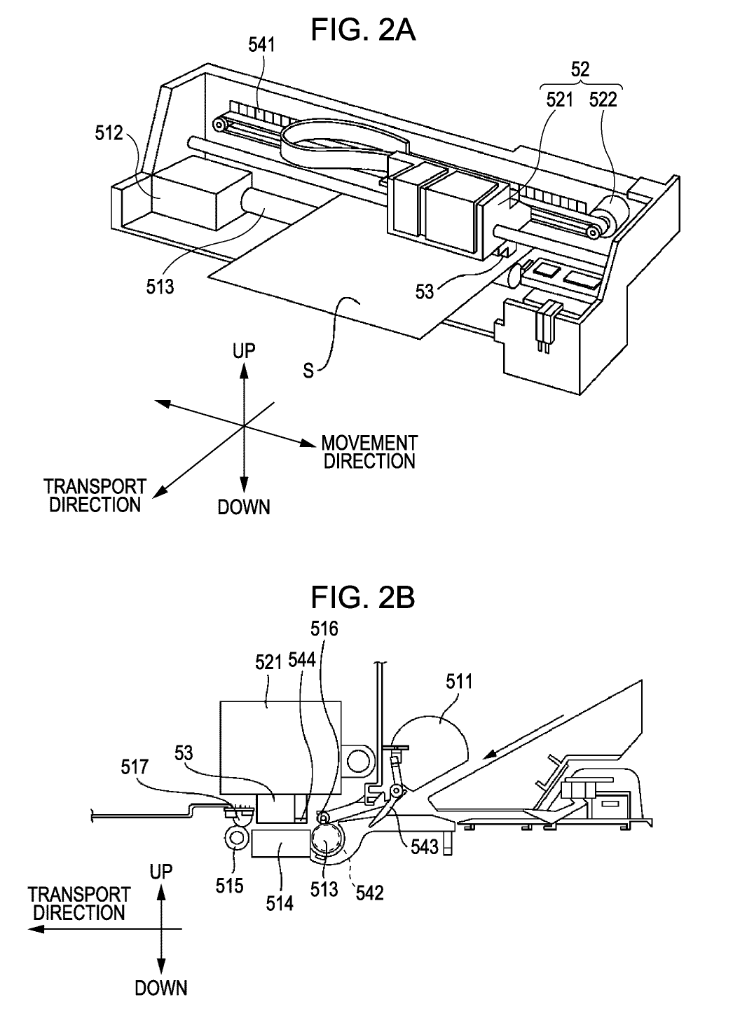

FIG. 2A is a schematic view of the printer unit 50, and FIG. 2B is a lateral cross-sectional view of the printer unit 50. Hereinafter, the configuration of the printer unit 50 will be described with reference to these figures and FIG. 1.

The printer unit 50 includes a transport unit 51, a carriage unit 52, a head unit 53, a detector group 54, a driving signal generation circuit 55, a dot dropout detection unit 56 (corresponding to an inspection unit), a cleaning mechanism 57 (corresponding to a recovery unit), and a counter 58. The units (the transport unit 51, the carriage unit 52, and the head unit 53) of the printer unit 50 are controlled by the controller 60. In addition, the printer unit 50 prints an image on a medium (for example, paper S) based on print data received from the controller 60. The state of the printer unit 50 is monitored by the detector group 54, and the detector group 54 outputs the detected result to the controller 60. The controller 60 controls the units based on the detected result output from the detector group 54.

The transport unit 51 transports the paper S in a predetermined direction. Hereinafter, this predetermined direction is referred to as a transport direction. The transport unit 51 includes a paper feed roller 511, a transport motor 512 (also called a PF motor), a transport roller 513, a platen 514, and an ejection roller 515. The paper feed roller 511 is a roller for feeding the paper S inserted into a paper insertion port in the printer. The transport roller 513 is a roller for transporting the paper S fed by the paper feed roller 511 to a printable region, and is driven by the transport motor 512. The platen 514 supports the paper S which is being printed. The ejection roller 515 is a roller for ejecting the paper S to the outside of the printer and is provided at a downstream side of the printable region in the transport direction. This ejection roller 515 is rotated synchronously with the transport roller 513.

In addition, when the paper S is transported by the transport roller 513, the paper S is sandwiched between the transport roller 513 and a driven roller 516. Accordingly, the posture of the paper S is stabilized. Meanwhile, when the paper S is transported by the ejection roller 515, the paper S is sandwiched between the ejection roller 515 and a driven roller 517.

The carriage unit 52 moves a head in a direction crossing the transport direction. Hereinafter, the direction crossing the transport direction is referred to as a movement direction. The carriage unit 52 includes a carriage 521 and a carriage motor 522 (also called a CR motor). The carriage 521 is reciprocally moved in the movement direction and is driven by the carriage motor 522. In addition, the carriage 521 detachably holds an ink cartridge which stores an ink.

The head unit 53 has a head 531 for ejecting the ink onto the paper S. In addition, a plurality of nozzles for ejecting the ink is provided in the lower surface of the head. The plurality of nozzles is formed in a nozzle plate 21. A piezoelectric element (not shown), which performs an operation for ejecting the ink from each of the nozzles, is provided in each of the nozzles.

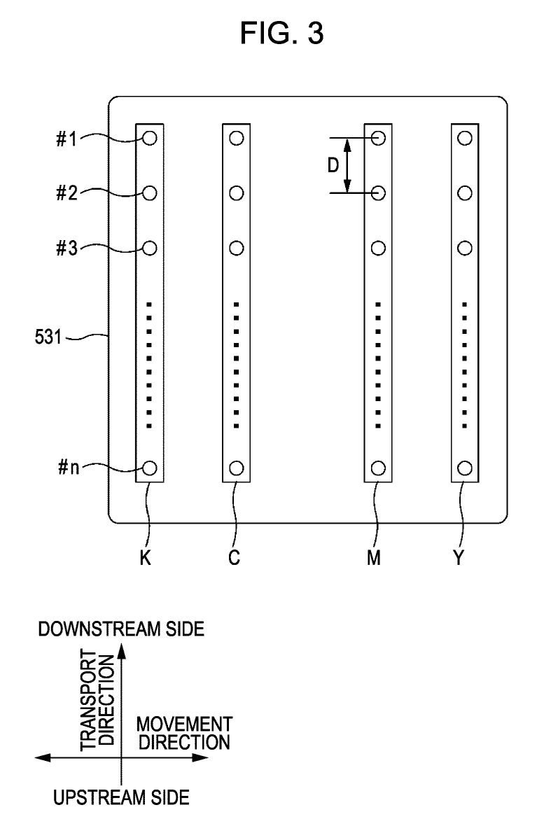

FIG. 3 is an explanatory view of the configuration of the head unit 53, and is a view of the head unit 53 when viewed from the top of the multifunction peripheral 1. The head unit 53 of the present embodiment has the head 531.

The head 531 has a plurality of nozzle arrays in which a plurality (n) of nozzles is arranged in the transport direction. In FIG. 3, the head has four nozzle arrays (a magenta (M) ink nozzle array, a yellow (Y) ink nozzle array, a cyan (C) ink nozzle array and a black (K) ink nozzle array, from the left side). The nozzles of each of the nozzle arrays are sequentially numbered (#1, #2, #3, . . . , #n) from the downstream side of the transport direction. The nozzles of each of the nozzle arrays are arranged in the transport direction with a nozzle pitch D. Since the head 531 is provided in the carriage 521, when the carriage 521 is moved in the movement direction, the head 531 is also moved in the same direction (movement direction). In addition, by intermittently ejecting the ink during the movement of the head 531, a dot array is formed on the paper S along the movement direction.

The detector group 54 includes a linear encoder 541, a rotary encoder 542, a paper detection sensor 543, and an optical sensor 544. The linear encoder 541 detects the position of the movement direction of the carriage 521. The rotary encoder 542 detects the amount of rotation of the transport roller 513. The paper detection sensor 543 detects the position of the front end of the paper S which is being fed. The optical sensor 544 detects the presence/absence of the paper S by a light-emitting unit and a light-receiving unit attached to the carriage 521. In addition, the optical sensor 544 uses the carriage 521 to detect the position of the end of the paper S while it is moving so as to detect the width of the paper S. In addition, the optical sensor 544 may detect the front end (the end of the downstream side of the transport direction) and the rear end (the end of the upstream side of the transport direction) of the paper S according to different situations.

The driving signal generation circuit 55 is a circuit for generating a driving signal COM. The driving signal COM is a signal applied to the piezoelectric element in order to eject the ink from the head 531. The driving signal generation circuit 55 generates the driving signal COM according to the command from the controller 60 and outputs the driving signal COM to the head unit 53.

The counter 58 counts the number of shots from the nozzles of the head 531. For example, the initial value of the counter 58 is zero and is counted up whenever the ink is ejected. If the count value is cleared by the controller 60, the count value is returned to the initial value.

The cleaning mechanism 57 recovers the ejection function of the nozzles by cleaning the head 531. The controller 60 allows the cleaning mechanism 57 to perform the cleaning of the head 531 when the detected result of the dot dropout detection circuit 56 indicates that the nozzles have become clogged. The cleaning method includes wiping clean, pumping clean and so on. The wiping clean is a process of wiping the nozzle surface of the head 531 with a wiper. The pumping clean is a process of sucking the ink from the nozzles by bringing a space of the nozzle surface side of the head 531 into a negative pressure.

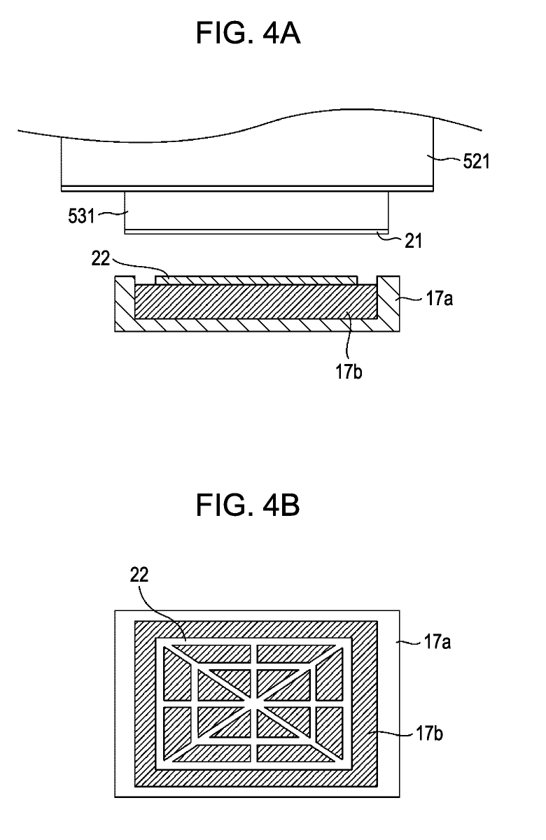

FIG. 4A is an explanatory view of a cap used for pumping clean. FIG. 4B is a view the cap when viewed from the top. The cap 17a is a box-shaped body of which a surface facing the head 531 is opened. Just before the carriage 521 reaches a home position, the head 531 faces the cap 17a. When the carriage 521 is further moved from that position to the home position side, the cap 17a rises. In addition, when the carriage 521 is positioned at the home position, the upper portion of the sidewall of the cap 17a (the opened edge of the cap 17a) is closely adhered to a nozzle plate 21 of the head 531 such that the cap 17a caps the head 531. During the pumping clean, the space of the nozzle plate 21 and the cap 17a is brought into a negative pressure by a pump in a state in which the cap 17a caps the head 531 such that the ink is sucked from the nozzles.

An absorber 17b is provided inside the cap 17a. The absorber 17b has a function for absorbing the sucked ink. In addition, moisture of the absorber 17b is retained. When the cap 17a caps the head 531 (when the carriage 521 is positioned at the home position), the nozzle plate 21 is prevented from drying up and thus the nozzles are prevented from becoming clogged.

In addition, in the present embodiment, a detection electrode 22 formed of a metal wire in a web shape is provided on the upper portion of the absorber 17b in the cap 17a. The detection electrode 22 will be described in detail later.

The dot dropout detection circuit 56 is a circuit for inspecting whether or not the liquid can be ejected from each of the nozzles. The configuration and the operation of the dot dropout detection circuit 56 will be described in detail later.

### Regarding Printing Order

The controller 60 performs the following process with respect to the units of the printer unit 50 when print data received from the computer 110 is printed, when the image data read by the scanner unit 40 is printed (copied), and when the image data received by the FAX control unit 70 is printed.

First, the controller 60 rotates the paper feed roller 511 and feeds the paper S to be printed to the position of the transport roller 513. Next, the controller 60 drives the transport motor 512 so as to rotate the transport roller 513. When the transport roller 513 is rotated by a predetermined amount, the paper S is transported by a predetermined transport amount.

When the paper S is transported to the lower portion of the head unit 53, the controller 60 rotates the carriage motor 522. By the rotation of this carriage motor 522, the carriage 521 is moved in the movement direction. By the movement of the carriage 521, the head unit 53 provided in the carriage 521 is simultaneously moved in the movement direction. The controller 60 intermittently ejects ink droplets from the head 531 while the head unit 53 is moved in the movement direction. The ink droplets hit the paper S such that a dot array in which a plurality of dots is arranged in the movement direction is formed.

The controller 60 drives the transport motor 512 while the head unit 53 is reciprocally moved. The transport motor 512 generates driving force of a rotation direction according to the driving amount commanded from the controller 60. The transport motor 512 rotates the transport roller 513 using this driving force. When the transport roller 513 is rotated by a predetermined amount, the paper S is transported by a predetermined transport amount. That is, the transport amount of the paper S is determined according to the amount of rotation of the transport roller 513. By repeatedly performing the reciprocal movement of the head unit 53 and the transport of the paper S, dots are formed at the pixels of the paper S. Accordingly, an image is printed on the paper S.

Finally, the controller 60 ejects the paper S on which printing is finished by the ejection roller 515 which is rotated synchronously with the transport roller 513.

### Regarding Method of Forming Dots

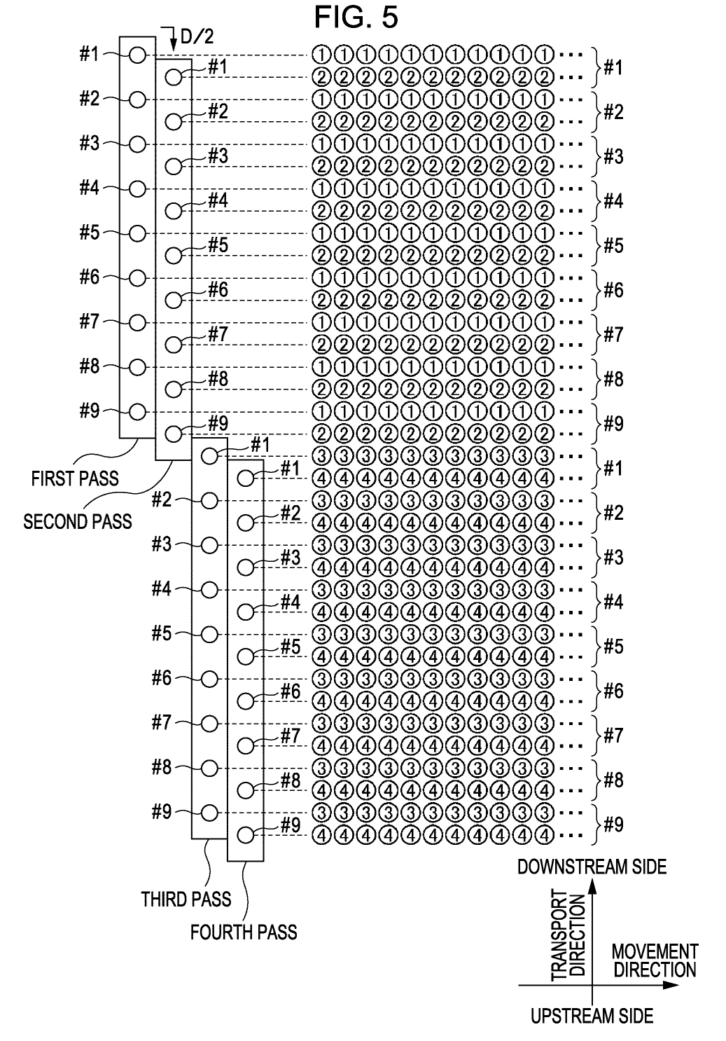

FIG. 5 is an explanatory view of a method of forming dots by the multifunction peripheral 1 according to the present embodiment. In FIG. 5, for simplification of description, one nozzle array (for example, a black nozzle array) of four nozzle arrays is shown. For simplification of description, the number of nozzles of the nozzle array is 9 (n=9). As described above, when printing is performed, the controller 60 alternately and repeatedly performs a dot forming operation for ejecting the ink from the head 531 which is being moved in the movement direction and a transport operation for transporting the paper S in the transport direction. Hereinafter, this dot forming operation is called “pass”. Circular marks of the right side of the figure represent dots and the numerals in the circular marks represent the number of passes in which the dot is formed.

In a first pass, the ink is ejected from the nozzles while the head 531 is moved in the movement direction. Accordingly, the dots are formed on the paper S at the positions corresponding to the nozzles (circular mark with a numeral 1 therein).

In the transport operation after the first pass, the paper S is transported by a half (D/2=0.5 D) of the nozzle pitch D in the movement direction. Accordingly, the position of the head relative to the paper S is moved to the upstream side of the movement direction by 0.5 D.

Even in a second pass, the ink is ejected from the nozzles while the head 531 is moved in the movement direction. Accordingly, the dots are formed on the paper S at positions corresponding to the nozzles (circular mark with a numeral 2 therein). For example, the second pass, the dot array is formed by the nozzle #1 between the dot array formed by the nozzle #1 during the first pass and the dot array formed by the nozzle #2.

In the transport operation after the second pass, the paper S is moved in the movement direction by 8.5 D (9 D-0.5 D). Accordingly, the position of the head relative to the paper S is moved to the upstream side of the movement direction by 8.5 D. That is, the nozzle #1 is positioned on the paper S on the upstream side of the transport direction 0.5 D further than the position of the nozzle #9 of the second pass.

Even in a third pass, the ink is ejected from the nozzles while the head 531 is moved in the movement direction. Accordingly, the dots denoted by circular marks with a numeral 3 therein are formed on the paper S.

Similarly, after an odd-numbered pass, the paper S is transported by 0.5 D in the movement direction and, after an even-numbered pass, the paper S is transported by 8.5 D in the movement direction.

Accordingly, as shown in the figure, the dot arrays arranged in the movement direction and the transport direction are formed on the paper S. By the above-described dot forming method, the dot array of the downstream side of the transport direction and the dot array of the upstream side of the transport direction adjacent thereto are formed by the nozzle #1. In addition, two dot arrays adjacent to the upstream side of the transport direction rather than the dot array formed by the nozzle #1 are formed by the nozzle #2. In the present embodiment, the dot arrays arranged in the movement direction are formed by one nozzle so as to be adjacent to each other in the transport direction.

### Configuration of Dot Dropout Detection Circuit

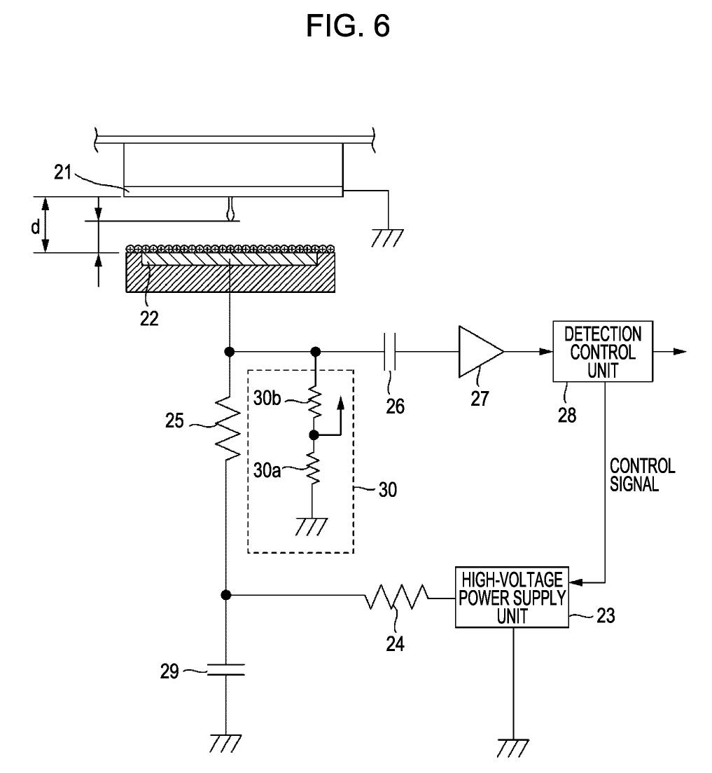

FIG. 6 is an explanatory view of the dot dropout detection circuit 56. The dot dropout detection circuit 56 includes a detection electrode 22, a high-voltage power supply unit 23, a first limiting resistor 24, a second limiting resistor 25, a detection capacitor 26, an amplifier 27, a detection control unit 28, a smoothing capacitor 29, and a voltage detection unit 30. The nozzle plate 21 of the head 531 is connected to the ground to be a ground potential, and functions as a portion of the dot dropout detection circuit.

The detection electrode 22 is formed of a metal wire in a web shape. The detection electrode 22 is provided on the absorber 17b in the cap 17a. Since a moisturizing agent or an ink absorbed in the absorber 17b is a conductive liquid (for example, water), if the detection electrode 22 is set to a high potential, the surface of the absorber 17b is set to the same potential. As a result, if the detection electrode 22 is set to the high potential, a wide region including the region of the metal wire having the web shape is set to a high potential.

The high-voltage power supply unit 23 is a power supply for setting the detection electrode 22 to a predetermined potential. The high-voltage power supply unit of the present embodiment is configured by a DC power supply of about 600 V to 1000 V.

The first limiting resistor 24 and the second limiting resistor 25 are interposed between the high-voltage power supply unit 23 and the detection electrode 22 so as to control the current flowing between the high-voltage power supply unit 23 and the detection electrode 22. Both the first limiting resistor 24 and the second limiting resistor 25 of the present embodiment have a resistance value of 1.6 MΩ.

The detection capacitor 26 is an element for extracting a potential change component of the detection electrode 22. One end of the detection capacitor 26 is connected to the detection electrode 22 and the other end thereof is connected to the amplifier 27. A bias component (DC component) of the detection electrode 22 is eliminated by the detection capacitor 26. The detection capacitor 26 of the present embodiment has capacitance of 4700 pF.

The amplifier 27 amplifies the signal of the other end of the detection capacitor 26. The amplifier 27 of the present embodiment has an amplification factor of 4000 times. Accordingly, a detection signal of which the potential is changed at about 3 V can be acquired from the amplifier 27.

The detection control unit 28 controls the dot dropout detection circuit and determines whether or not the nozzles are clogged based on the detection signal output from the amplifier 27. The method of determining whether or not the nozzles are clogged will be described later.

The smoothing capacitor 29 suppresses a rapid change of a potential. One end of the smoothing capacitor 29 is connected to the first limiting resistor 24 and the second limiting resistor 25 and the other end thereof is connected to the ground. The capacitance of the smoothing capacitor 29 of the present embodiment is 0.1 μF.

The voltage detection unit 30 detects whether or not the detection electrode 22 has a predetermined voltage. The voltage detection unit 30 has a first resistor 30a and a second resistor 30b configuring a voltage division circuit. The first resistor 30a and the second resistor 30b are connected in series, one end of the first resistor 30a is set to the same potential as the detection electrode 22, and the second resistor 30b is connected to ground. A potential (voltage detection signal) between the first resistor 30a and the second resistor 30b is detected by the controller 60 so as to detect whether or not the detection electrode 22 has the predetermined voltage. The first resistor 30a of the present embodiment has a resistance value of 6 MΩ and the second resistor 30b has a resistance value of 33 kΩ.

### Operation of Dot Dropout Detection Circuit

When the ink is ejected from the nozzles formed in the nozzle plate 21, the potential of the detection electrode 22 is changed, this potential change is detected by the detection capacitor 26 and the amplifier 27, and the detection signal is output to the detection control unit 28. If the nozzles are clogged, since the ink is not ejected, the potential of the detection electrode 22 is not changed and the voltage change does not appear in the detection signal.

This principle is accurately explained, but is considered as follows. Generally, if a distance d between two conductors configuring the capacitor is changed, it is known that charges Q accumulated in the capacitor are changed. If the ink is ejected from the nozzle plate 21 having the ground potential to the high-potential detection electrode 22, the distance d between the ink droplets having the ground potential and the detection electrode 22 is changed and thus the charges Q accumulated in the detection electrode 22 are changed when the distance d between the two conductors of the capacitor is changed. As a result, the charges are moved to the detection electrode 22, the current flowing at this time is detected by the detection capacitor 26 and the amplifier 27, and the detection signal is output to the detection control unit 28.

### Operation of Dot Dropout Detection

Next, the operation of the dot dropout detection will be described. In the following description, the number of nozzles of each of the nozzle arrays is 180 (n=180).

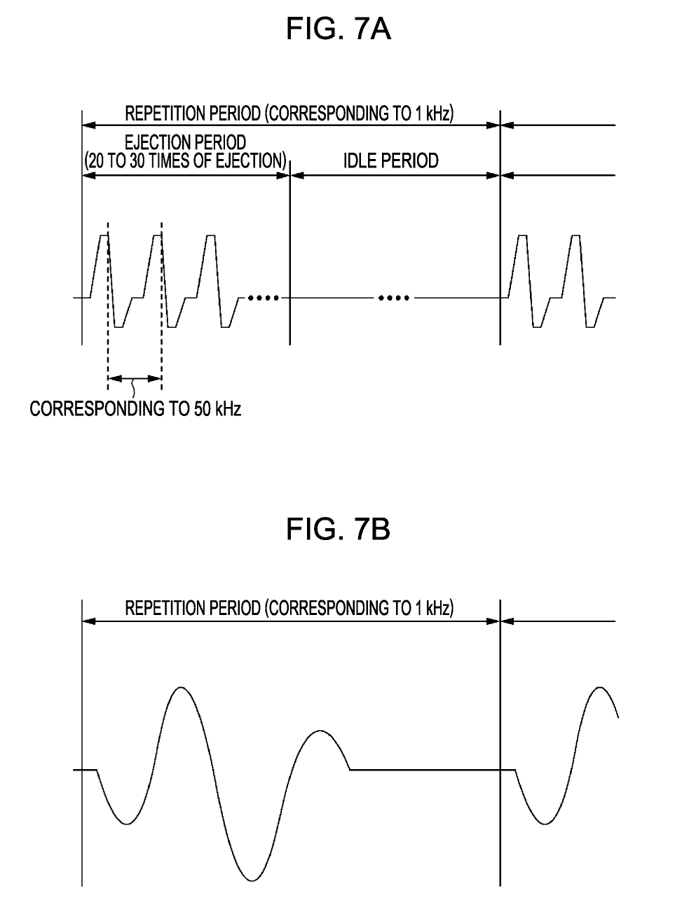

FIG. 7A is an explanatory view of a driving signal COM for driving the piezoelectric element of each of the nozzles. The controller 60 repeatedly outputs the driving signal COM shown in the figure to the driving signal generation circuit 55 in a period of 1 kHz. The driving signal generation circuit 55 outputs the driving signal COM to the head unit 53. The controller 60 controls a head control unit (not shown) of the head unit 53 and applies the driving signal COM to the piezoelectric element of each of the nozzles to be inspected.

The repetition period of the figure is a period necessary for inspecting any one nozzle. The driving signal COM of a first half portion of this period includes 20 to 30 ink ejection pulses at an interval of 50 kHz. The driving signal COM of a second half portion is set to a constant potential (intermediate potential).

If such a driving signal COM is applied to the piezoelectric element, 20 to 30 ink droplets are ejected from the nozzle corresponding to the piezoelectric element at an interval of 50 kHz.

FIG. 7B is an explanatory view of the detection signal when ink droplets are ejected. If 20 to 30 ink droplets are ejected from the nozzle in the repetition period of FIG. 7A at the interval of 50 kHz, the detection signal shown in FIG. 7B is output from the amplifier 27.

The detection control unit 28 detects the amplitude of the detection signal output from the amplifier 27 during any repetition period, compares the detected amplitude with a predetermined threshold value, and determines that the ink is ejected from the nozzle to be inspected if the detected amplitude is greater than the threshold value. In contrast, if the detected amplitude is less than the threshold value, it is determined that the ink is not ejected from the nozzle to be inspected.

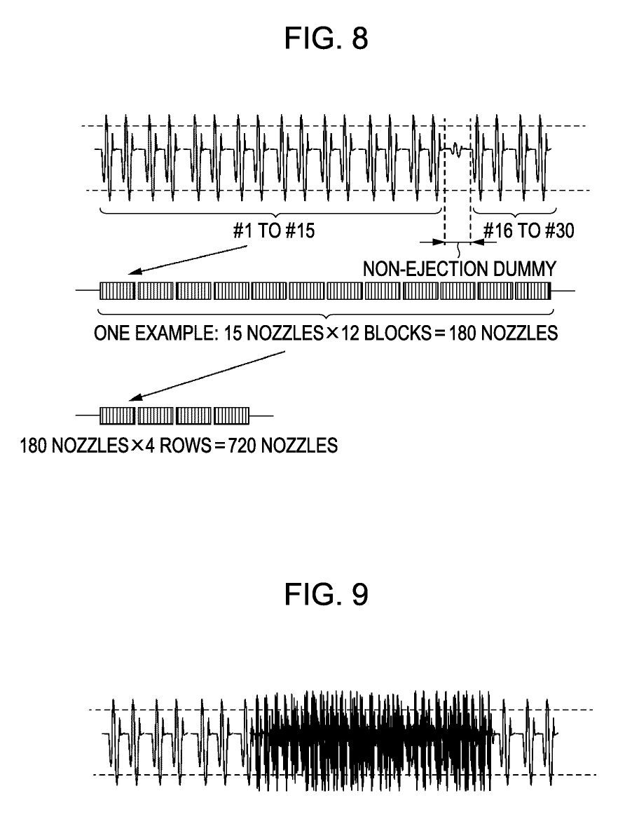

FIG. 8 is an explanatory view of the detection signal. The controller 60 switches the piezoelectric element for applying the driving signal COM and switches the nozzle to be inspected in each repetition period. As shown in the upper side of the figure, if the ink is sequentially ejected from 15 nozzles #1 to #15, the detection signal corresponding to each of the nozzles is output in each repetition period. The detection control unit 28 compares the amplitude of the detection signal with the threshold value (corresponding to a lateral dotted line of the upper side of the figure) so as to inspect each of the nozzles. By performing the inspection of the 15 nozzles 12 times, the inspection of one nozzle array is performed (the central portion of the figure). By performing the inspection of one nozzle array four times, the inspection of the nozzle array of four colors is performed (the lower side of the figure).

FIG. 9 is an explanatory view when noise is included in the detection signal. The potential change of the detection electrode 22 when the ink droplets are ejected is minute and, in the present embodiment, the minute potential change is amplified to 4000 times by the amplifier 27 in order to detect the minute potential change. Since the amplification factor of the amplifier 27 is large, the noise of the detection signal output from the amplifier 27 may be increased. As a result, the amplitude of the detection signal exceeds the threshold value due to the noise and thus the nozzle which does not eject the ink may not be detected even when the nozzle which does not eject the ink is present.

In the present embodiment, a period in which the ink is not ejected from any nozzle is provided during the inspection of 15 nozzles. For example, a period in which the ink is not ejected from any nozzle (a “non-ejection dummy” of the upper side of the figure) is provided after the inspection of the nozzle #15 and before the inspection of the nozzle #16. In other words, the controller 60 controls the driving signal COM not to be applied to any piezoelectric element after the driving signal COM is applied to the piezoelectric element corresponding to the nozzle #15 and before the driving signal COM is applied to the piezoelectric element corresponding to the nozzle #16. In addition, the period in which the ink is not ejected from any nozzle (the period of the “non-ejection dummy”) is identical to the above-described repetition period.

The detection control unit 28 compares the amplitude of the detection signal of each period with the threshold value in each repetition period, stores “1” in a register if the amplitude of the detection signal exceeds the threshold value, and stores “0” in the register if the amplitude of the detection signal does not exceed the threshold value. Even in the period of the non-ejection dummy, similarly, the amplitude of the detection signal in that the period is compared with the threshold value and the compared result is stored in the register. The controller 60 reads 16-bit data of the register of the detection control unit 28 at timing when 16 compared results (the compared results of 15 nozzles and the compared result of the non-ejection dummy period) are stored in the register.

In the 16-bit data, if the compared results of the 15 nozzles are “1” and the data corresponding to the non-ejection dummy is “0”, the controller 60 determines that the ink droplets are normally ejected from the 15 nozzles. For example, for 16-bit data “1111111111111110”, the controller 60 determines that the ink droplets are normally ejected from the 15 nozzles.

In contrast, if the data corresponding to the non-ejection dummy of the 16-bit data is “1”, since the noise included in the detection signal is large, an error may occur in the previous compared results of the 15 nozzles. Accordingly, the controller 60 inspects the previous 15 nozzles again if the data corresponding to the non-ejection dummy of the 16-bit data is “1”. For example, if the 16-bit data is “1111111111111111” when the nozzles #1 to #15 are inspected, the controller 60 inspects the nozzles #1 to #15 again. In addition, even when the re-inspection is performed a predetermined number of times (for example, six times), if the data corresponding to the non-ejection dummy is continuously “1”, it is determined that the dot dropout detection operation is abnormal, and a message indicating that the dot dropout detection operation is abnormal is displayed on a display screen (not shown).

If the compared result of any one of the 15 nozzles of the 16-bit data is “0” and the data corresponding to the non-ejection data is “0”, the controller 60 specifies the nozzle having the compared result of “0” and it is determined that the nozzle does not eject the ink. For example, if the 16-bit data is “1101111111111110” when the nozzles #1 to #15 are inspected, the controller 60 determines that the nozzle #3 does not eject the ink.

The controller 60 can determine whether or not a nozzle which does not eject the ink is present and the positions (nozzle numbers) and the number of the nozzles which do not eject the ink, by referring to the 16-bit data obtained by the dot dropout inspection.

By performing the above-described dot dropout inspection at predetermined timing (timing according to a time or a print amount) during printing, it is possible to efficiently detect the nozzle which does not eject the ink (hereinafter, referred to as a “non-ejection nozzle”). If the non-ejection nozzle is detected, for example, by performing the cleaning of the nozzle, it is possible to prevent the deterioration of the image quality of a printed image.

If the cleaning is performed, a printing time is increased. In particular, the multifunction peripheral 1 of the present embodiment has a FAX function. The printing during the FAX receiving needs to be rapidly performed without failure.

In the following embodiments, the dot dropout detection and the cleaning during the FAX printing is improved.

### First Embodiment

In printing using the FAX function (hereinafter, referred to as FAX printing), the image data received by the FAX control unit 70 is sent to the memory 63 and is temporarily stored. The controller 60 allows the printer unit 50 to perform printing based on the image data stored in the memory 63 according to a print command from the FAX control unit 70.

In the FAX printing, the image data stored in the memory 63 may be erased from the memory 63 after printing. Accordingly, in the FAX printing, if the printing fails due to the clogging of the nozzle, the received data may not be printed again. Therefore, in the present embodiment, the printing deterioration during the FAX printing is prevented. In detail, during the FAX receiving, the above-described dot dropout inspection is necessarily performed before printing.

In the case of FAX, even when all the nozzles cannot eject the ink, if the number of nozzles which cannot eject the ink is a predetermined value or less, it is possible to perform printing with a certain degree of visibility. Hereinafter, the reason will be described.

### Printing During Fax Receiving

In the FAX, in order to reduce the communication amount of data, data with low resolution is transmitted or received and is printed in a state of increasing the resolution. At this time, the resolution of the received data is simply converted vertically or horizontally, which will be described later. In detail, the multifunction peripheral 1 of the present embodiment receives data having 97.2 dpi during FAX receiving and converts the resolution of the data to 360 dpi during printing. In other words, one pixel of the data received by the FAX control unit 70 is divided into 3 to 4 pixels such that dots are formed in the divided pixels. In this case, one pixel of the original image is averagely divided into about 3.7 pixels during printing.

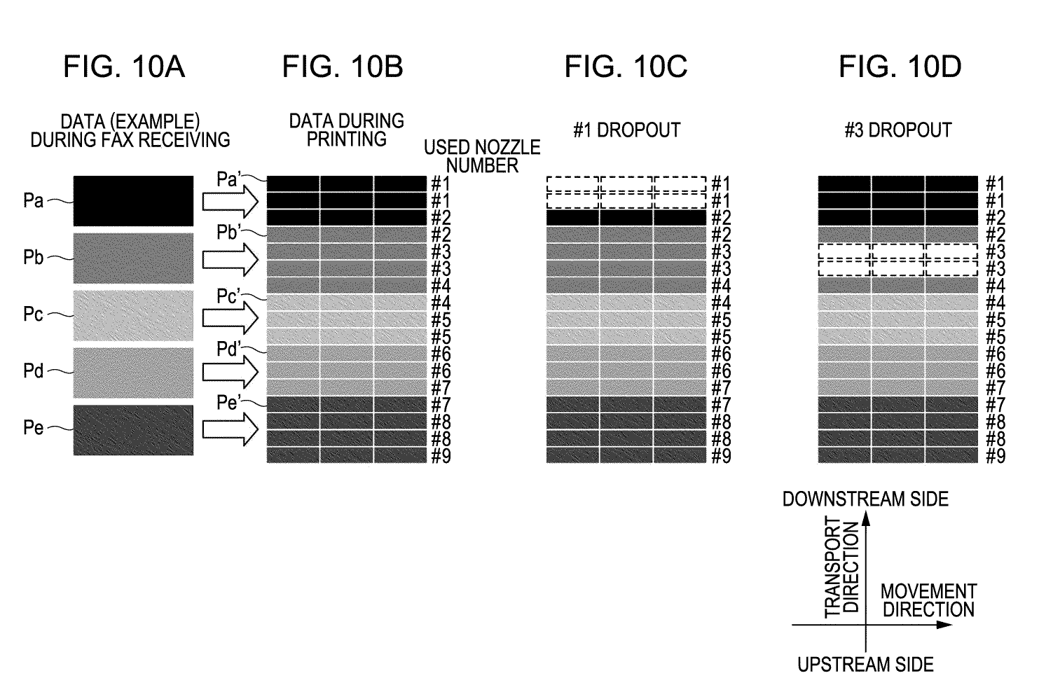

FIGS. 10A to 10D are views explaining resolution conversion during FAX printing. FIG. 10A shows the data an image (hereinafter, also called original image) during FAX receiving, FIG. 10B shows image data during printing, FIG. 10C is a view showing an image printed when the nozzle #1 is clogged, and FIG. 10D is a view showing an image printed when the nozzle #3 is clogged. The blocks of the figures denote the pixels (dots) of the images. The portions denoted by dotted lines of FIGS. 10C and 10D indicate portions in which the dots are not formed. The numerals shown on the right side of FIGS. 10B to 10D indicate the nozzle numbers corresponding to the pixels during printing.

In the FAX printing of the multifunction peripheral 1 of the present embodiment, an image is printed based on binary data of white (absence of the dot) and black (presence of the dot). That is, data indicating whether or not the dot is formed in each pixel, and printing is performed. In the figure, the case where the dots are formed in the pixels Pa to Pe of the original image is shown.

The resolution of the pixel Pa of the original image received by the FAX shown in FIG. 10A is tripled vertically and horizontally during printing, as shown in FIG. 10B. In other words, the pixel Pa is divided into 9 pixels Pa′ during printing. In addition, the resolution of the pixel Pb of the original image is quadrupled vertically and horizontally during printing. In other words, the pixel Pb is dived into 16 pixels Pb′ during printing. Similarly, the pixel Pc, the pixel Pd and the pixel Pe are divided into 9 pixels Pc′, 9 pixels Pd′ and 16 pixels Pe′, respectively. The dots are formed by the nozzles corresponding to the divided pixels.

For example, in FIG. 10B, in two rows from the top (downstream side of the transport direction) of the rows arranged in the movement direction of the pixels Pa′ configured in three horizontal rows and three vertical columns, the dots are formed by the nozzle #1. In the remaining rows of the pixels Pa′ and the uppermost rows of the pixels Pb′, the dots are formed by the nozzle #1 and the nozzle #2. That is, in the pixels Pa′ corresponding to the pixel Pa, the dots are formed by the nozzles #1 and #2. In the pixels PB′ corresponding to the pixels Pb, the dots are formed by the nozzle #2, the nozzle #3 and the nozzle #4. The dots are formed in the plurality of pixels corresponding to one pixel of the original image using two or three nozzles. If any pixel of the original image is divided and the dots are formed using a predetermined number (2 to 3 in the present embodiment) of nozzles with respect to the plurality of divided pixels, the predetermined number of nozzles is referred to as the nozzles corresponding to the pixel of the original image. For example, in FIG. 10B, the nozzles corresponding to the first pixel (pixel Pa) of the original image are the nozzle #1 and the nozzle #2.

If the nozzle #1 is clogged such that the ink cannot be ejected, the image shown in FIG. 10C is obtained. In this case, the dots can be formed in a portion of the plurality of pixels Pa′ corresponding to the pixel Pa by the nozzle #2.

In addition, if the nozzle #3 is clogged such that the ink cannot be ejected, the image shown in FIG. 10D is obtained. In this case, the dots can be formed in a portion of the plurality of pixels Pb′ corresponding to the pixel Pb by the nozzle #2 and the nozzle #4.

In the FAX printing of the present embodiment, one pixel of the original image is divided into 3 to 4 pixels in one direction and, in two pixels of them, the dots are formed by one nozzle. That is, in the FAX printing, at least two nozzles are used with respect to one pixel of the original image. Accordingly, in the FAX printing, if the number of nozzles (non-ejection nozzles) which do not eject the ink is less 2 (that is, 1 or zero), the dots can be formed in at least a portion of the pixels of the original image. In this case, an image with the lowest visibility can be printed even when the cleaning of the nozzles is not performed. That is, if the number of non-ejection nozzles is 1, it is allowable. Hereinafter, the number of non-ejection nozzles is referred to as an allowable value. In the present embodiment, the allowable value is 1 as described above.

This allowable value depends on the size of resolution conversion, a nozzle pitch, and a printing method (the number of nozzles used for forming the dots in the plurality of divided pixels). As the value of resolution conversion is increased (that is, the division number is increased, the allowable value is increased. For example, if one pixel is divided into five pixels or more, at least three nozzles are used with respect to one pixel of the original image. In this case, if the number of non-ejection nozzles is less than 3, the allowable value becomes 2. In addition, in FIG. 10, if the nozzle pitch is a half of that of the present embodiment, or if dot arrays which are adjacent to each other in the transport direction are formed by different nozzles, not by one nozzle, one pixel of the original image is formed by at least three nozzles. Even in this case, the allowable value becomes 2.

In the FAX printing, if the number of non-ejection nozzles is within the allowable value, at least the dots can be formed with respect to all the pixels of the original image. Accordingly, an image with lowest visibility can be printed. Accordingly, even when it is detected that the non-ejection nozzles are present by the dot dropout inspection, if the number of non-ejection nozzles is within the allowable value, the cleaning of the nozzles is not performed. Therefore, the printing time can be shortened and the unnecessary consumption of the ink can be suppressed.

### Regarding Printing Process of First Embodiment

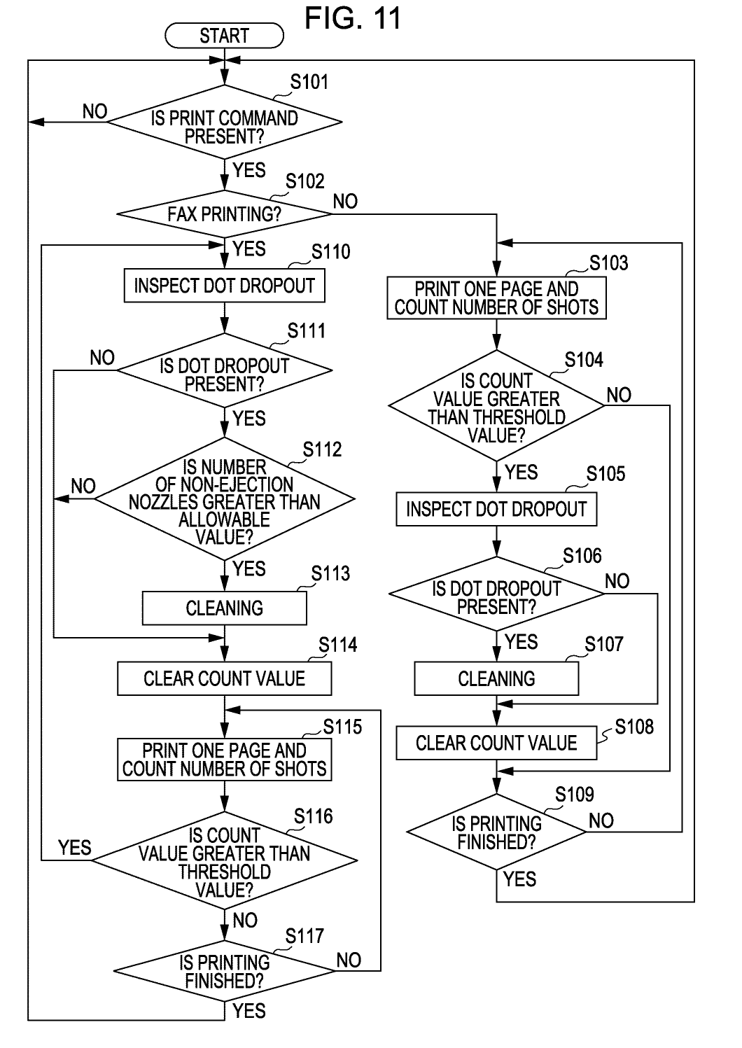

FIG. 11 is a flowchart of a printing process according to a first embodiment.

First, the controller 60 repeatedly determines whether or not a print command is present until the print command is issued (S101). If it is determined that the print command is present (YES in S101), it is determined whether or not the print command is FAX printing (S102). That is, it is determined whether or not the command is a command for printing the image data received by the FAX control unit 70.

If it is determined that the print command is not FAX printing (NO in S102), for example, if the print data from the computer 110 is printed or if the image data read by the scanner unit 40 is printed, the controller 60 allows the printer unit 50 to print one page according to the print command and, at this time, the number of shots is counted by the counter 58 (S103). If the printing of one page is finished, the controller 60 determines whether or not the value (hereinafter, referred to as a count value) counted by the counter 58 is greater than a predetermined threshold value (S104).

If it is determined that the count value is greater than the threshold value (YES in S104), the controller 60 allows the dot dropout detection circuit 56 to perform a dot dropout inspection (S105). If it is determined that dot dropout is present as the result of the dot dropout inspection (YES in S106), the cleaning mechanism 57 is allowed to perform the cleaning of the nozzles (S107).

After the cleaning of the nozzles and if it is determined that dot dropout is absent in step S106 (NO in S106), the controller 60 clears the count value of the counter 58 (S108). Accordingly, the count value becomes an initial value (for example, zero). After the count value is cleared and if it is determined that the count value is the threshold value or less in step S104 (NO in S104), the controller 60 determines whether or not the printing has finished (S109). If the printing has not finished (NO in S109), the process returns to step S103 and the printing of a next page and the count of the number of shots are performed. If the printing has finished (YES in S109), the process returns to step S101, and it is determined whether or not a next print command is present.

In FIG. 11, if the determination is NO in step S102, one page is initially printed. This is because it is determined that the count value is less than the threshold value when the printing by the previous print command is finished or the count value is cleared. For example, if a plurality of pages is printed by one print command, the printing of a first page can be immediately started and the determination of step S104 can be performed during the printing of the first page. The step S103 may be performed after step S108, after the determination is NO in step S104, and before step S109, instead of the position of FIG. 11. In this way, for example, even when the printing of only one page is performed by one print command, in the timing when the dot dropout inspection should be performed, the dot dropout inspection may be performed so as to determine whether or not the dot dropout is present before the printing is started or the printing may be started after the dot dropout is solved.

Meanwhile, in step S102, if it is determined that the print command is the FAX printing (YES in S102), the controller 60 allows the dot dropout detection circuit 56 to perform the dot dropout inspection (S110). If it is determined that the dot dropout is present as the result of the dot dropout inspection, that is, if it is determined that the non-ejection nozzle is present (YES in S111), it is determined whether or not the number of non-ejection nozzles is greater than the allowable value (S112). In the present embodiment, as described above, it is determined whether or not the number of non-ejection nozzles is greater than 1. If it is determined that the number of non-ejection nozzles is greater than the allowable value (YES in S112), that is, if the number of non-ejection nozzles specified from the above-described 16-bit data is 2 or more, the controller 60 allows the cleaning mechanism 57 to perform the cleaning of the nozzles (S113). After the cleaning of the nozzles is finished, if it is determined that the dot dropout is absent in step S111 (NO in S111), and it is determined that the number of non-ejection nozzles is the allowable value (1, in the present embodiment) or less in step S112 (NO in S112), the controller 60 clears the count value of the counter 58 (S114). Accordingly, the count value becomes the initial value (zero).

Thereafter, the controller 60 allows the printer unit 50 to perform the printing of one page and allows the counter 58 to count the number of shots (S115). Then, after printing one page, it is determined whether or not the count value is greater than the threshold value (S116). If it is determined that the count value is greater than the threshold value (YES in S116), the process returns to step S110. If it is determined that the count value is the threshold value or less (NO in step S116), it is determined whether or not the printing is finished (S117). If it is determined that the printing is not finished (NO in S117), the process returns to step S115 and the printing of a next page and the count of the number of shots are performed. If it is determined that the printing is finished in step S117 (YES in S117), the process returns to step S101, and it is determined whether or not a next print command is present.

Although, in FIG. 11, in step S112, it is determined whether or not the number of non-ejection nozzles is greater than the allowable value, the same determination as used in step S106 may be performed and the same dot dropout allowable degree as for general printing may be used. In the embodiment shown in FIG. 11, the allowable degree of the non-ejection nozzles during the FAX printing may be different from that during the general printing and thus printing suitable for the FAX printing can be performed.

In FIG. 11, after step S115, it is determined whether or not the same dot dropout inspection as the general printing of step S116 is performed. This is because it is determined whether or not dot dropout is present by the dot dropout inspection or a possibility that the dot dropout suddenly occurs is low (in particular, dropout does not rapidly occur in a plurality of nozzles) after the dot dropout is solved by the cleaning, and, if the printing is performed in order to read the characters like the FAX printing, the printing needs to be rapidly and continuously performed without consuming time by the dot dropout inspection or the cleaning. After step S115, the process progresses to step S117. If NO, the process returns to step S110 and the dot dropout inspection may be performed whenever one page is printed.

Although, in FIG. 11, when the cleaning of step S107 is performed, the process progresses to step S108 and step S109, and the printing of one page is performed if the printing is not finished in step S109, in this case, after the cleaning of step S107, the process progresses to step S105 and the dot dropout inspection may be performed again. In this case, if the determination is YES in step S106 even when the cleaning is performed a predetermined number of times, an error may be presented or the confirmation whether or not the printing is performed may be presented to a user.

Meanwhile, even after the cleaning of step S113, the process returns to the dot dropout inspection of step S110. In this case, if the determination is YES in step S112 even when the cleaning is performed a predetermined number of times, the process may progress to step S115.

In the present embodiment, in printing other than FAX, the dot dropout inspection is performed according to the print amount (the number of shots). In the FAX printing, the dot dropout inspection is necessarily performed before printing. Therefore, it is possible to prevent the deterioration of the image quality when the FAX printing is performed.

In the present embodiment, in the FAX printing, even when the non-ejection nozzle is detected by the dot dropout inspection, if the number of non-ejection nozzle is within the allowable value (1 in the present embodiment), the printing is performed without performing the cleaning of the nozzles. In this case, since an image with low visibility can be printed, it is possible to shorten the print time.

### Second Embodiment

The second embodiment is different from the first embodiment in the process after the non-ejection nozzles are detected in the dot dropout inspection of the FAX printing. In the second embodiment and the below-described embodiments, a portion which is not specially described is similar to that of the first embodiment.

As described above, in the present embodiment, one pixel of an original image is divided into at least three pixels, and two adjacent pixels are formed by one nozzle. Accordingly, one pixel of the original image is formed by at least two successive nozzles. Therefore, if at least two non-ejection nozzles are not successive, it is possible to form at least the dots with respect to the pixels of the original image.

For example, in FIG. 10, if the nozzles #1 and #3 are clogged, it is possible to form the dots by the nozzle #2 in the pixels Pa′ corresponding to the pixel Pa of the original image and form the dots by the nozzle #2 or #4 in the pixels Pb′ corresponding to the pixel Pb. If two non-ejection nozzles are present but are not successive, it is possible to print an image with low visibility.

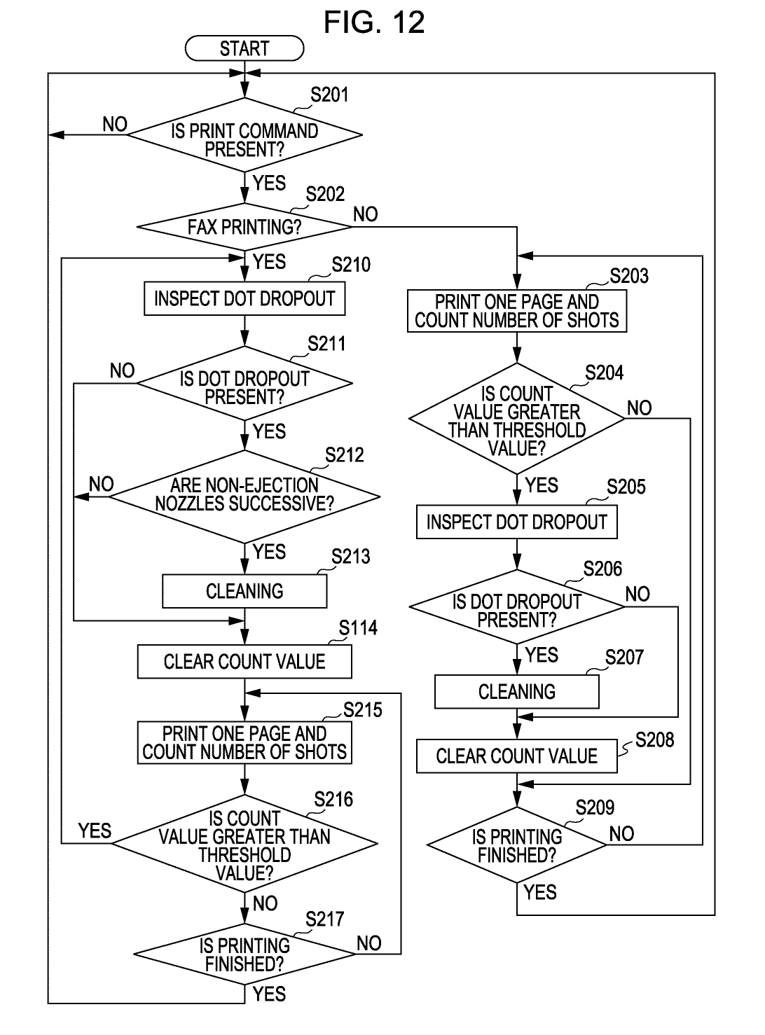

FIG. 12 is a flowchart of a printing process according to the second embodiment. In FIG. 12, since steps S201 to S211 and S213 to S217 respectively correspond to the steps S101 to S111 and S113 to S117 of the first embodiment, the description thereof will be omitted. The second embodiment is different from the first embodiment in the process of a step S212.

In the dot dropout inspection (S210) of the FAX printing, if the dot dropout (non-ejection nozzles) is detected (YES in S211), the controller 60 determines whether or not the nozzle numbers of the detected non-ejection nozzles are successive (S212). If it is determined that the successive nozzles (for example, the nozzles #1 and #2) are non-ejection nozzles (YES in S212), the controller 60 allows the cleaning mechanism 57 to perform the cleaning of the nozzles (S213). In contrast, if it is determined that the non-ejection nozzles are successive (NO in S212), the controller 60 clears the count value of the counter 58 (S214) and the printing of one page and the count of the number of shots are performed (S215).

In the second embodiment, in the FAX printing, even the non-ejection nozzles are detected by the dot dropout inspection, if the non-ejection nozzles are not successive, the printing is performed without performing the cleaning of the nozzles. Accordingly, it is possible to shorten the printing time.

Even in the second embodiment, in the FAX printing, the dot dropout inspection is necessarily performed before printing. Accordingly, it is possible to prevent the deterioration of the image quality when the FAX printing is performed.

### Third Embodiment

The third embodiment is different from the above-described embodiments in the process after the non-ejection nozzles are detected in the dot dropout inspection of the FAX printing.

As described above, in the present embodiment, one pixel of an original image is divided into at least three pixels, and the dots are formed in the divided pixels using at least two nozzles. That is, at least one of a plurality of nozzles corresponding to one pixel of the original image can eject the ink.

For example, in FIG. 10, in the pixels Pa′ divided from the pixel Pa, the dots are formed by the nozzle #1 and the nozzle #2. In this case, if at least one of the nozzle #1 and the nozzle #2 can eject the ink, the pixel Pa of the original image can be represented. In addition, in the pixels PB′ divided from the pixel Pb, the dots are formed by the nozzle #2, the nozzle #3 and the nozzle #4. In this case, for example, even when the successive nozzles #3 and #4 cannot eject the ink, if the nozzle #2 can eject the ink, the pixel of the original image can be represented. If at least one of the nozzle #2, the nozzle #3 and the nozzle #4 can eject the ink, the pixel Pb of the original image can be represented.

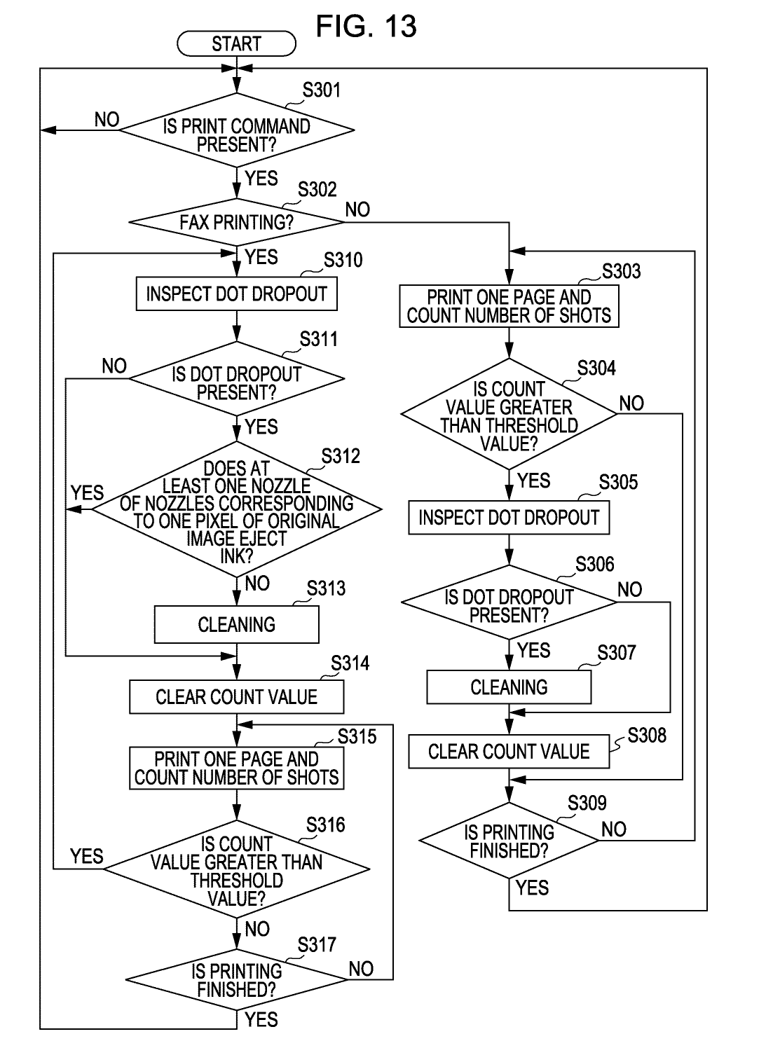

FIG. 13 is a flowchart of a printing process according to the third embodiment. In FIG. 13, since steps S301 to S311 and S313 to S317 respectively correspond to the steps S101 to S111 and S113 to S117 of the first embodiment, the description thereof will be omitted. The third embodiment is different from the above-described embodiments in the process of a step S312.

In the dot dropout inspection (S310) of the FAX printing, if the dot dropout (non-ejection nozzles) is detected (YES in S311), the controller 60 determines whether or not at least one of the nozzles corresponding to one pixel of the original image can eject the ink (S312). For example, in FIG. 10, it is determined whether each of any one of the nozzle #1 and the nozzle #2 corresponding to the pixel Pa, any one of the nozzles #2 to #4 corresponding to the pixel Pb, any one of the nozzles #4 and #5 corresponding to the pixel Pc, any one of the nozzles #6 and #7 corresponding to the pixel Pd, and any one of the nozzles #7 to #9 corresponding to the pixel Pe can eject the ink, by referring to the above-described 16-bit data.

If it is determined that all the plurality of nozzles corresponding to the pixels of the original image are the non-ejection nozzles (NO in S312), the controller 60 allows the cleaning mechanism 57 to perform the cleaning of the nozzles (S313). For example, if both the nozzles #1 and #2 are the non-ejection nozzles, the pixel Pa of the original image is not represented. Accordingly, in this case, the cleaning of the nozzles is performed.

In contrast, if it is determined that at least one of the nozzles corresponding to one pixel of the original image can eject the ink (YES in S312), the controller 60 clears the count value of the counter 58 (S314), and the printing of one page and the count of the number of shots are performed (S315).

In the third embodiment, in the FAX printing, even the non-ejection nozzles are detected by the dot dropout inspection, if at least one of the nozzles corresponding to one pixel of the original image can eject the ink, the printing is performed without performing the cleaning of the nozzles. Accordingly, it is possible to shorten the printing time.

Even in the third embodiment, in the FAX printing, the dot dropout inspection is necessarily performed before printing. Accordingly, it is possible to prevent the deterioration of the image quality when the FAX printing is performed.

### Fourth Embodiment

Although, in the above-described embodiments, the dot dropout inspection is performed to the print amount (the number of shots), a next dot dropout inspection is performed according to the lapse of time after a dot dropout inspection is performed in the fourth embodiment. In the fourth embodiment, if dot dropout is detected by the dot dropout inspection during the FAX printing, it is determined whether or not the number of non-ejection nozzles is greater than the allowable value, similar to the first embodiment.

First, the controller 60 starts a timer by a predetermined condition (for example, the conduction of the multifunction peripheral 1) (S401). The controller 60 repeatedly determines whether or not a print command is present until the print command is issued (S402). If it is determined that the print command is present (YES in S402), it is determined whether or not the print command is FAX printing (S403).

If it is determined that the print command is FAX printing (NO in S403), the controller 60 determines whether or not the value of the timer is greater than a predetermined threshold value (S404). If it is determined that the value of the timer is greater than the threshold value (YES in S404), the controller 60 allows the dot dropout detection circuit 56 to perform the dot dropout inspection (S405). If it is determined that dot dropout is present as the result of the dot dropout inspection (YES in S406), the controller 60 allows the cleaning mechanism 57 to perform the cleaning of the nozzles (S407). After the cleaning of the nozzles and if the dot dropout is not detected in step S406, the controller 60 resets the measurement of the time (S408) and starts the measurement again.

After the timer is reset and if it is determined that the value of the timer is the threshold value or less in step S404 (NO in S404), the controller 60 allows the printer unit 50 to print one page (S409). After one page is printed, it is determined whether or not the printing is finished (S410). If it is determined that the printing is finished, the process returns to step S404 and it is determined whether or not the value of the timer is greater than the threshold value. If it is determined that the printing is finished in step S410, the process returns to step S402 and it is determined whether a next print command is present.

In contrast, in step S403, if it is determined that the print command is FAX printing (YES in S403), the controller 60 allows the dot dropout detection circuit 56 to perform the dot dropout inspection (S411). If it is determined that dot dropout is present as the result of the dot dropout inspection, that is, if it is determined that the non-ejection nozzle is present (YES in S412), it is determined whether or not the number of non-ejection nozzles is greater than the allowable value (S413). In the present embodiment, as described above, it is determined whether or not the number of non-ejection nozzles is greater than 1. If it is determined that the number of non-ejection nozzles is greater than the allowable value (YES in S413), the controller 60 allows the cleaning mechanism 57 to perform the cleaning of the nozzles (S414). In addition, after step S414 is finished, if it is determined that dot dropout is not present in step S412 (NO in S412), and if the number of non-ejection nozzles is the allowable value (1 in the present embodiment) or less in step S413 (NO in S413), the controller 60 resets the measured value of the timer (S415) and starts the measure again.

Thereafter, the controller 60 allows the printer unit 50 to print one page (S416). After one page is printed, it is determined whether or not the value of the timer is greater than the threshold value (S417). If it is determined that the value of the timer is greater than the threshold value (YES in S417), the process progresses to step S411. If it is determined that the value of the timer is the threshold value or less (NO in S417), it is determined whether or not the printing is finished (S418). If it is determined that the printing is finished (NO in S418), the process returns to S416 and a next page is printed. If it is determined that the printing is finished (YES in S418) in step S418, the process returns to step S402 and it is determined whether or not a next print command is present.

In the fourth embodiment, the dot dropout inspection is performed according to the time measured by the timer. In addition, in the FAX printing, the dot dropout inspection is necessarily performed before printing, regardless of time. Accordingly, it is possible to prevent the deterioration of the image quality when the FAX printing is performed.

In the dot dropout inspection of the FAX printing, if the number of non-ejection nozzles is within the allowable value (1 in the present embodiment), printing is performed without performing the cleaning of the nozzles. Accordingly, it is possible to shorten a printing time while ensuring low visibility.

### Other Embodiments

The above-described embodiments are made for facilitating the understanding of the invention and are not intended to limit the invention. The invention may be modified or changed without departing from the scope of the invention, and the invention includes the equivalents thereof. In particular, the following embodiments are also included in the invention.

### Regarding Printing Device

Although, in the above-described embodiments, the multifunction peripheral 1 is, for example, described as the printing device, the printing device is not limited to the multifunction peripheral 1. For example, a printing device without the scanner unit 40 or without a scanner function or a copy function may be used.

### Regarding Dot Dropout Inspection

The dot dropout inspection for detecting whether or not the ink can be ejected from the nozzles may be used, and inspection methods other than the above-described method may be used. For example, dot dropout may be inspected by passing ink droplets through light flux and inspecting the shielding of light flux due to the ink droplets or dot dropout may be inspected by printing a test pattern on a print medium and reading the test pattern with a sensor.

### Regarding Timing of Dot Dropout Inspection

Although, in the first to third embodiments, the number of shots is counted and the dot dropout inspection is performed according to the number of shots, the inspection may be performed by timing according to the print amount. For example, the number of sheets of paper may be counted and the dot dropout inspection may be performed according to the number of sheets of paper or the number of passes may be counted and the dot dropout inspection may be according to the number of passes.

### Regarding Timing of Inspection of FAX Printing

In the above-described embodiments, if it is determined that the printing is FAX printing, the dot dropout inspection is performed. For example, in FIG. 11, if the determination is YES in step S102, the dot dropout inspection is performed in step S110. The invention is not limited to such embodiments. For example, in FIG. 11, if the determination is YES in step S102, the count value is compared with a predetermined threshold value, the process progresses to step S110 if the count value is greater than the threshold value, the process progresses to step S115 if the count value is not greater than the threshold value. In this case, the predetermined threshold value is different from the threshold value referred to in step S104 and may be a predetermined threshold value which allows the frequency of the dot dropout inspection to be higher than that in step S104.

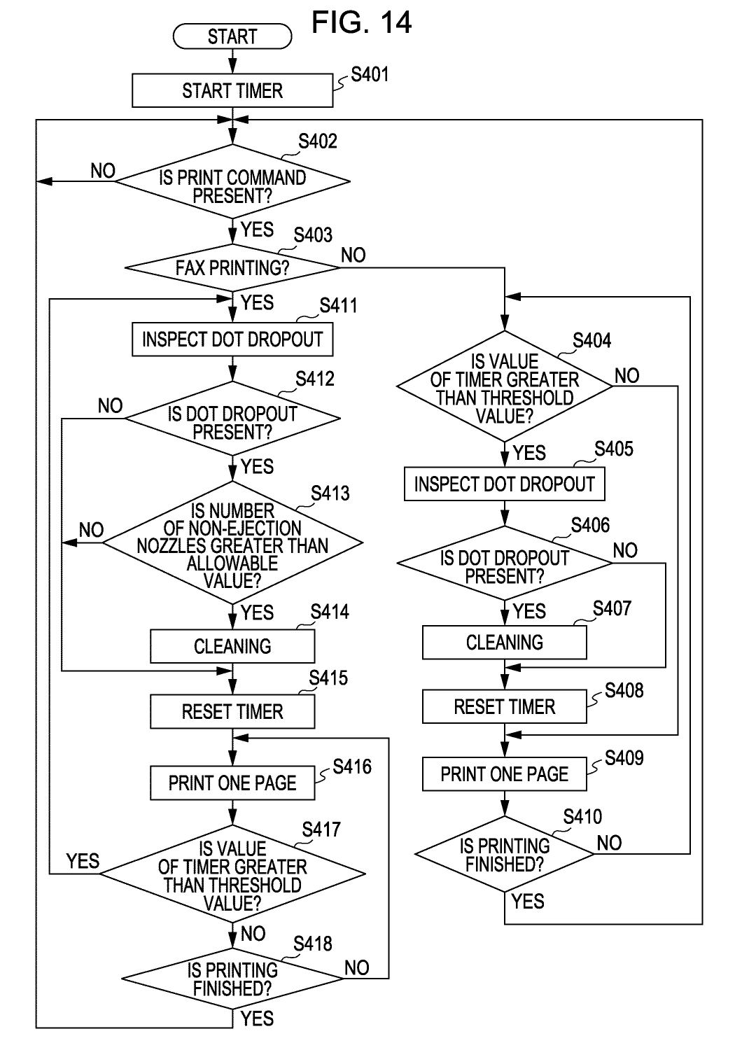

For example, if the number of sheets of paper is used as the print amount, the threshold value referred to in step S104 may be 20 and the threshold value referred to when the determination is YES in step S102 may be 2. In the embodiment of FIG. 14, the threshold value referred to in step S404 may be one day and the threshold value referred to when the determination is YES in step S403 may be one hour. Such a threshold value may be, for example, a threshold value which allows the frequency of the dot dropout inspection during the FAX printing to be higher than that during the general printing. In this way, the FAX printing is performed at timing which allows the frequency of dot dropout inspection to be higher than that in the general printing, and thus the deterioration of the image quality during the FAX printing can be prevented. In the above-described embodiments, since one threshold value is used, it is possible to simplify control.

### Regarding Cleaning

Although, in the above-described embodiments, the cleaning of the nozzles is performed if dot dropout is detected, the invention is not limited to the cleaning if an operation for recovering the ejection function of the nozzles is performed.

If dot dropout is detected by the dot dropout inspection during the FAX printing, the cleaning is not performed and an error may be reported to a source of the FAX.

What is claimed is:

1. A printing device comprising:
a printing unit which has a plurality of nozzles for ejecting a liquid and prints an image;
an inspection unit which inspects whether or not the liquid can be ejected from each of the nozzles;
a facsimile unit which receives image data via a communication line; and
a controller which allows the inspection unit to perform the inspection at a predetermined timing when the printing unit performs the printing based on image data other than image data received by the facsimile unit and allows the inspection unit to perform the inspection before the printing regardless of the predetermined timing when the printing unit performs the printing based on the image data received by the facsimile unit.

2. The printing device according to claim 1, further comprising a recovery unit which performs a recovery operation for recovering an ejection function of a nozzle which does not eject the liquid,
wherein the controller allows the recovery unit to perform the recovery operation according to the inspected result of the inspection unit.

3. The printing device according to claim 2, wherein:
each of the pixels of the image data is divided into a plurality of pixels and at least a predetermined number of nozzles is used for the plurality of divided pixels, when the printing is performed based on the image data received by the facsimile unit, and
the controller allows the printing unit to perform the printing without allowing the recovery unit to perform the recovery operation if at least one of the predetermined number of nozzles corresponding to each of the pixels of the image data can eject the liquid as the inspected result of the inspection unit.

4. The printing device according to claim 3, wherein the controller determines that at least one of the predetermined number of nozzles corresponding to each of the pixels of the image data can eject the liquid if the number of nozzles which do not eject the liquid is less than the predetermined number as the inspected result of the inspection unit.

5. The printing device according to claim 1, wherein the predetermined timing is determined according to the print amount of the printing unit.

6. The printing device according to claim 1, wherein the predetermined timing is determined according to a time.

7. A printing method of a printing device which has a plurality of nozzles for ejecting a liquid and prints an image based on image data, the method comprising:
inspecting whether or not the liquid can be ejected from each of the nozzles; and
receiving image data via a communication line,
wherein the inspection is performed at a predetermined timing when the printing is performed based on image data other than image data received by a facsimile unit and the inspection is performed before the printing regardless of the predetermined timing when the printing is performed based on the image data received by the facsimile unit.

8. A printing device comprising:
a printing unit which has a plurality of nozzles for ejecting a liquid and prints an image;
an inspection unit which inspects whether or not the liquid can be ejected from each of the nozzles;
a facsimile unit which receives image data via a communication line; and
a controller which allows the inspection unit to perform the inspection at a predetermined timing when the printing unit performs the printing based on image data other than image data received by the facsimile unit and allows the inspection unit to perform the inspection before the printing at timing with frequency higher than that of the predetermined timing when the printing unit performs the printing based on the image data received by the facsimile unit.
